(19) United States
(12) Patent Application Publication
(10) Pub. No.: US 2005/0039564 A1
(43) Pub. Date: Feb. 24, 2005

(54) Pedal assembly for a vehicle including a non-contact position sensor

(76) Inventors: Jiyuan Ouyang, Windsor (CA); Brad Menzies, Holly, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/921,575

(22) Filed: Aug. 19, 2004

Related U.S. Application Data
(60) Provisional application No. 60/496,626, filed on Aug. 20, 2003.

(51) Int. Cl. G01B 7/14

(52) U.S. Cl. 74/514

(57) ABSTRACT

The subject invention provides a pedal assembly (10, 110, 210) for a vehicle and a non-contact position sensor (22). The pedal assembly (10, 110, 210) includes a bracket (12. 112, 212) and a pedal arm (14, 114, 214). A pivot (16) supports the pedal arm (14, 114, 214) for pivotal movement about a pivot axis A. The pivot (16) includes a fixed element (18) and a rotatable element (20). The rotatable element (20) is rotatable relative to the fixed element (18) about the pivot axis A. The position sensor (22) is disposed on the pivot axis A. The position sensor (10, 110, 210) includes a magnetic flux sensor (24) that is supported by one of the elements (18, 20) on the pivot axis A. First (26) and second (28) magnetic poles are supported by the other of the elements (18, 20). The magnetic poles (26, 28) present opposing surfaces (30, 32) of opposite magnetic polarity. The poles (26, 28) are in spaced and parallel relationship and are on opposite sides of the pivot axis A to create substantially uniform flux density B over a predetermined distance D parallel to the surfaces (30, 32) of the magnetic poles (26, 28).

### RELATED APPLICATIONS

This patent application claims priority to and all advantages of U.S. Provisional Patent Application No. 60/496,626, which was filed on Aug. 20, 2003.

### BACKGROUND OF THE INVENTION

1. Field of the Invention

The subject invention relates to non-contact position sensors for use in pedal assemblies for vehicles. More specifically, the subject invention relates to non-contact position sensors that utilize magnetic flux sensors to sense a relative angle between a fixed element and a rotatable element.

2. Description of the Prior Art

Such magnetic flux sensors are commonly employed in pedal assemblies for vehicles having a bracket and a pedal arm to sense an angle of the pedal arm in relation to the bracket as a driver presses and releases the pedal arm.

In particular, U.S. Pat. No. 6,396,259 discloses a non-contact position sensor suitable for pedal assemblies. The position sensor includes a ring-shaped magnet having inner and outer surfaces disposed about a pivot axis. The magnet is diametrically magnetized, i.e., North and South poles are disposed on opposite surfaces on opposite sides of the pivot axis to provide magnetic lines of flux across the pivot axis of the magnet. A magnetic flux sensor is disposed between the first and second sides of the magnet on the pivot axis and senses the magnetic lines of flux to generate output signals. The output signals depend on the angle of rotation between the flux sensor and the magnetic lines of flux.

In operation, the flux sensor rotates in relation to the magnet, or vice versa. However, the magnetic lines of flux are arcuate and variably spaced, which produces non-parallel lines of flux and results in a non-uniform flux density. Accordingly, the sensor output is dependent on both the non-uniform flux density and a changing angle of the sensor relative to the non-parallel lines of flux. The non-uniform flux density produces output signals from the flux sensor that are not proportional to the degree of rotation, i.e., the plot produces a curve of constantly changing slope or a non-linear function. Because of the difference in flux density across the non-parallel lines of flux in the lateral direction relative to the pivot axis, the output signals from the flux sensor will vary depending upon the lateral position of the flux sensor. More specifically, different lateral positions of the flux sensor relative to the pivot axis will produce different curves for the output signals, thereby requiring very close tolerances in the positioning of the flux sensor during fabrication.

### SUMMARY OF THE INVENTION AND ADVANTAGES

The subject invention provides a pedal assembly for a vehicle and a non-contact position sensor for use therein. The pedal assembly includes a bracket for attachment to the vehicle and a pedal arm. A pivot supports the pedal arm for pivotal movement relative to the bracket about a pivot axis. The pivot includes a fixed element and a rotatable element. The rotatable element is rotatable relative to the fixed element about the pivot axis in response to the pivotal movement of the pedal arm. A magnetic flux sensor is supported by one of the elements. First and second magnetic poles are supported by the other of the elements. The magnetic poles present opposing surfaces of opposite magnetic polarity. The poles are in spaced and parallel relationship to one another, and the flux sensor is positioned between the poles. The poles create substantially uniform flux density over a predetermined distance parallel to the surfaces of the magnetic poles.

The poles produce magnetic lines of flux that are substantially parallel, which produces the substantially uniform flux density. The substantially uniform flux density produces output signals from the flux sensor that are substantially proportional to a degree of rotation of the flux sensor relative to the poles, i.e., the plot produces a curve of substantially constant slope. Because of the substantial uniform flux density across the substantially parallel lines of flux in the lateral direction relative to the pivot axis, the output signals from the flux sensor will remain substantially constant regardless of the lateral position of the flux sensor within the predetermined distance of the uniform flux density. More specifically, different lateral positions of the flux sensor relative to the poles will produce substantially similar curves for the output signals, thereby allowing a tolerance in the lateral position of the flux sensor relative to the poles.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is an exploded perspective view of a pedal assembly;

FIG. 2 is a partial side view of the pedal assembly of FIG. 1;

FIG. 3 is a perspective view of a non-contact position sensor;

FIG. 4 is a schematic view of another embodiment of the non-contact position sensor;

FIG. 5 is a schematic view of a magnetic flux sensor;

FIG. 6 is a graph illustrating a relationship between angle of rotation for the magnetic flux sensor and sensor output in flux density;

FIG. 7 is another graph illustrating a best fit relationship between angle of rotation for the magnetic flux sensor and non-linearity between the sensor outputs of FIG. 6 and a straight line connecting the sensor output at zero degrees of rotation and fifteen degrees of rotation;

FIG. 8 is a side view of another embodiment of a pedal assembly including the non-contact position sensor;

FIG. 9 is a side view of another embodiment of a pedal assembly including the non-contact position sensor; and

FIG. 10 is a schematic view of the non-contact position sensor of FIG. 4 showing various flux densities within the sensor.

### DETAILED DESCRIPTION OF THE PREFERRED EMBODIMENT

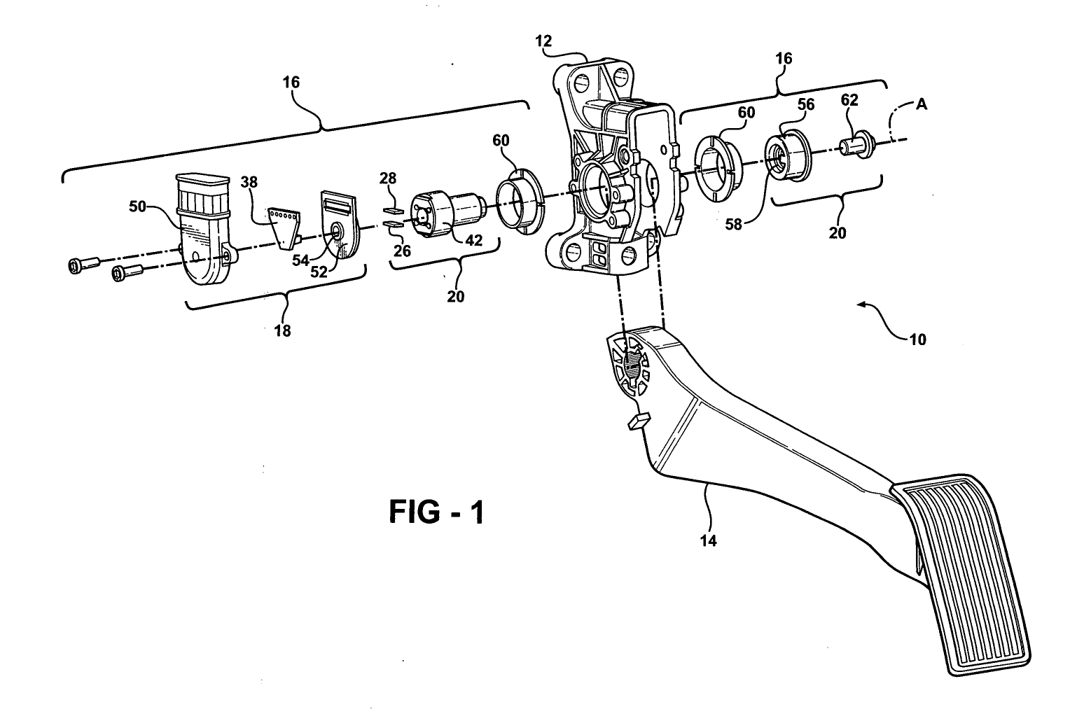

Referring to the Figures, wherein like numerals indicate like or corresponding parts throughout the several views, a pedal assembly for a vehicle is shown generally at 10, 110, 210 in FIG. 1. The pedal assembly 10, 110, 210 may be mounted to a body of the vehicle.

The pedal assembly 10, 110, 210 includes a bracket 12, 112, 212 that is fixed against rotational movement and that is mountable to the vehicle. The pedal assembly 10, 110, 210 further includes a pedal arm 14, 114, 214. A pivot 16 supports the pedal arm 14, 114, 214 for pivotal movement relative to the bracket 12, 112, 212 about a pivot axis A. The pivot 16 includes a fixed element 18 and a rotatable element 20. A magnetic flux sensor 24 is supported by one of the elements 18, 20. The flux sensor 24 has a face 34 that presents a straight longitudinal axis. Preferably, the magnetic flux sensor 24 is disposed on the pivot axis A; however, the flux sensor 24 may deviate laterally from the pivot axis A, as will be discussed in further detail below. The flux sensor 24 generates output signals By based on a position of the pedal arm 14, 114, 214.

A pair of first 26 and second 28 magnetic poles are supported by the other of the elements 18, 20. More specifically, the flux sensor 24 is preferably supported by the fixed element 18, and the poles 26, 28 are supported by the rotatable element 20, with the flux sensor 24 positioned between the poles 26, 28. Preferably, the first 26 and second 28 magnetic poles are further defined as first 26 and second 28 magnets; however, the first 26 and second 28 magnetic poles may be part of the same magnet. The poles 26, 28 and the flux sensor 24 together form a magnetic position sensor 22. The poles 26, 28 present opposing surfaces 30, 32 of opposite magnetic polarity. The poles 26, 28 are in spaced and parallel relationship to one another and are preferably on opposite sides of the pivot axis A. However, it is to be appreciated that the poles 26, 28 may be on the same side of the pivot axis A so long as the flux sensor 24 and the poles 26, 28 are rotatable relative to one another with the flux sensor 24 positioned between the poles 26, 28. The poles 26, 28 create substantially uniform flux density B over a predetermined distance D parallel to the surfaces of the poles 26, 28. To create the substantially uniform flux density B, the opposing surfaces 30, 32 are straight. Based on the shape, position, and polarity of the poles 26, 28, the poles 26, 28 create substantially parallel magnetic lines of flux 36 across the pivot axis A, which in turn define the substantially uniform flux density B. Furthermore, as a result of the substantially uniform flux density B, the flux sensor 24 retains a consistent output signal By over a predetermined relative range of rotation between the flux sensor 24 and the poles 26, 28 at various lateral positions of the flux sensor 24 relative to the pivot axis A.

Preferably, the substantially uniform flux density B is further defined as a difference in flux density of no more than 1500 Gauss throughout the predetermined distance D. In a most preferred embodiment, the substantially uniform flux density B is further defined as a flux density in the range of from 2000 to 3500 Gauss throughout the predetermined distance D. By maintaining the substantially uniform flux density B within the aforementioned range, error in the output signals By from the flux sensor 24 is minimized. The output signals By may be correlated to throttle or braking control of the vehicle.

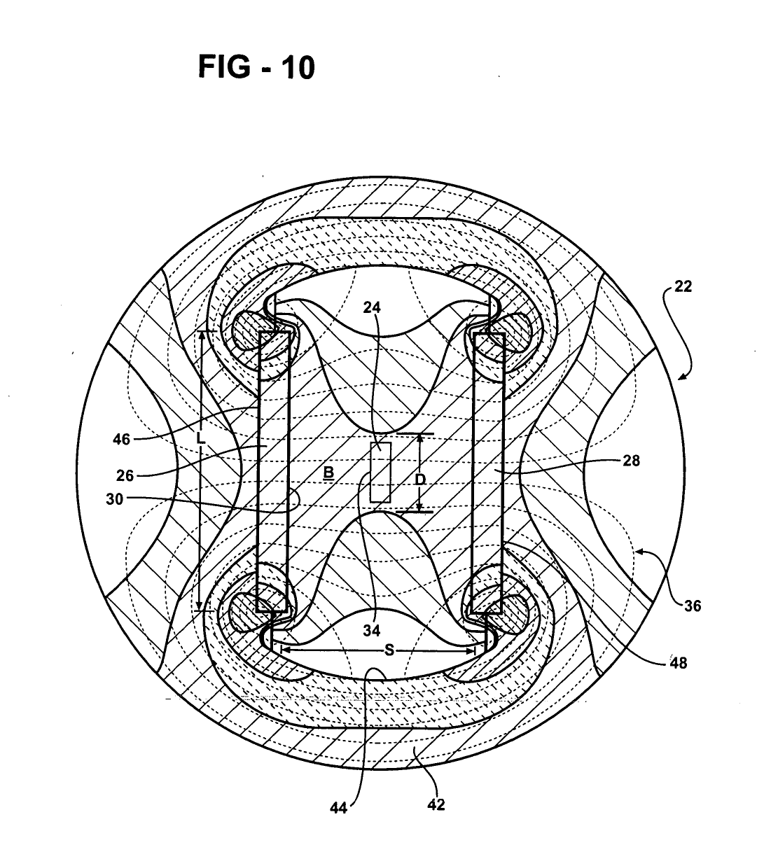

Referring to FIG. 10, flux sensor 24 is shown at a full 90 degree rotation relative to the poles 26, 28. In addition, various flux densities are indicated by various cross-hatchings. The predetermined distance D of substantially uniform flux density B is preferably on either side of the pivot axis A and surrounds the flux sensor 24. More specifically, the predetermined distance D is preferably defined as a distance at least equal to a length of the flux sensor 24, and is more preferably a distance greater than a length of the flux sensor 24 for allowing a tolerance in the lateral position of the flux sensor 24 relative to the poles 26, 28 while retaining the flux sensor 24 within the substantially uniform flux density 24 throughout the full range of rotation between the flux sensor 24 and the poles 26, 28.

The substantially uniform flux density B is attributed to the substantially parallel feature of the magnetic lines of flux 36. The substantially parallel feature of the magnetic lines of flux 36 are dependent on multiple variables, for example, strength of the magnetic poles 26, 28, a space S between the magnetic poles 26, 28, a length L of the magnetic poles 26, 28, and shape of the magnetic poles 26, 28, among other features such as the presence of a rotor 42 for concentrating the flux, which will be described in further detail below. The aforementioned variables also control the size of the predetermined distance D, as discussed above. In order to produce the substantially parallel magnetic lines of flux 36, the magnetic poles 26, 28 preferably extend the length L at least equal to the space S between the opposing surfaces 30, 32. In addition, the opposing surfaces 30, 32 are preferably formed from a rigid material such as a sintered alloy comprising iron to enable maximum physical and magnetic strength of the magnetic poles. Curved magnetic poles tend to be formed from more flexible material, such as plastic, and cannot achieve the same physical and magnetic strength as straight magnetic poles formed from the sintered alloy. However, it is to be appreciated that the first 26 and second 28 magnetic poles may be formed from materials other than iron.

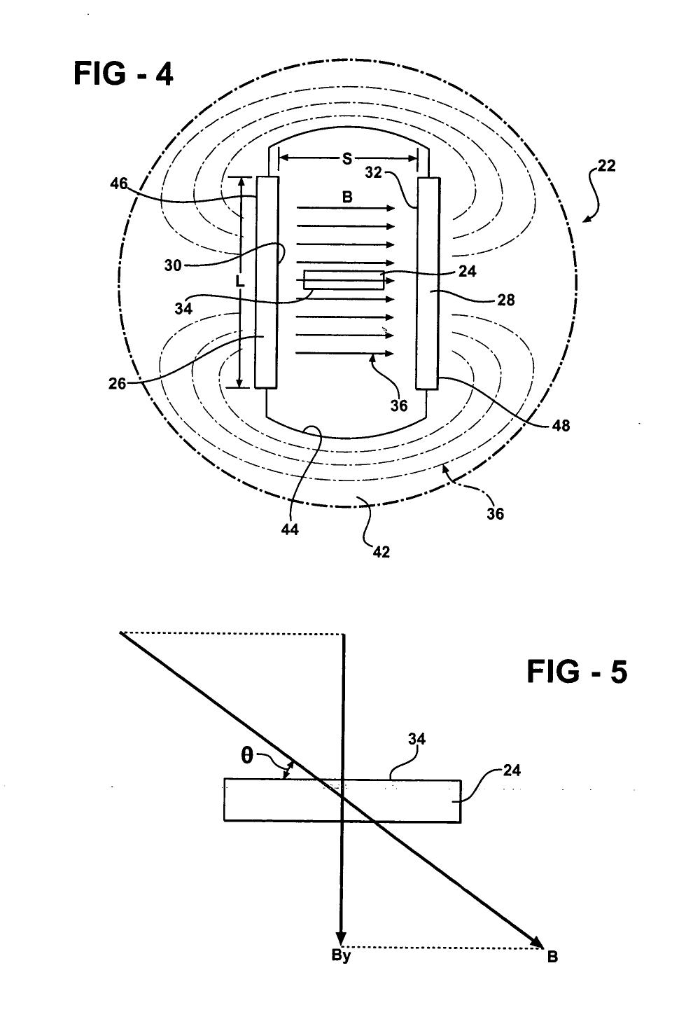

In a preferred embodiment, the other of the elements 18, 20 also includes a rotor 42 coaxial with the pivot axis A. More specifically, the rotor 42 is disposed on the same element 18, 20 as the magnetic poles 26, 28. Preferably, the rotor 42 has a circular shape, but may define other shapes depending on spatial constraints for the non-contact position sensor 22. The rotor 42 has an inner surface 44 radially spaced from and extending parallel to and about the pivot axis A. The magnetic poles 26, 28, more specifically the magnets 26, 28, are disposed on the inner surface 44. The magnets 26, 28 have the opposing surfaces 30, 32, respectively, of opposite polarity. The magnets 26, 28 also have outward-facing surfaces 46, 48, respectively, that are also of opposite polarity. Thus, as shown in FIG. 4, the outward-facing surfaces 46, 48 also produce the magnetic lines of flux 36, which extend away from the pivot axis A. Preferably, the rotor 42 is formed from a material that is magnetizeable, such as iron, for facilitating the magnetic lines of flux 36 to extend from and between the magnets 26, 28 and through the rotor 42. Thus, the rotor 42 serves as a flux concentrator to channel the magnetic lines of flux 36 from the outward-facing surfaces 46, 48 and between the magnets 26, 28, which increases the flux density B across the pivot axis A. The rotor 42 also shields the flux sensor 24 from outside magnetic fields that may affect the output signals B_{y} from the flux sensor 24.

Preferably, the pedal arm 14, 114, 214 rotates within a range of fifteen degrees. Accuracy and stability of the output signals By through the range of rotation is important for braking and throttle control. The position sensor 22, in order to provide output signals B_{y} that are accurate and stable, exhibits minimal non-linearity per degree of rotation between the flux density B of the magnetic lines of flux 36 and the output signal B_{y}. As previously stated, the position sensor 22 also exhibits minimal sensitivity to lateral movements between the flux sensor 24 and the magnetic poles 26, 28. Non-linearity results in distortion of the output signals, which hinders a correlation between an angle θ of the magnetic lines of flux 36, which correlates to an angle of the pedal, and the output signals B_{y}.

Referring to FIGS. 4 and 5, the output signals B_{y} are based on the magnetic flux density B and the angle θ between the magnetic lines of flux 36 and the face 34 of the flux sensor 24. More specifically, the flux sensor 24 operates according to Hall Effect principles. Thus, the output signals B_{y} are based on the following equation:
|B_{y}|=|B|sin θ
Since the substantially parallel magnetic lines of flux 36 are of substantially constant flux density B, the output signals B_{y} from the flux sensor 24 exhibit minimal non-linearity. Furthermore, the flux sensor 24 produces consistent output signals B_{y} at various lateral positions relative to the pivot axis A, so long as the flux sensor 24 remains within the substantially parallel magnetic lines of flux 36.

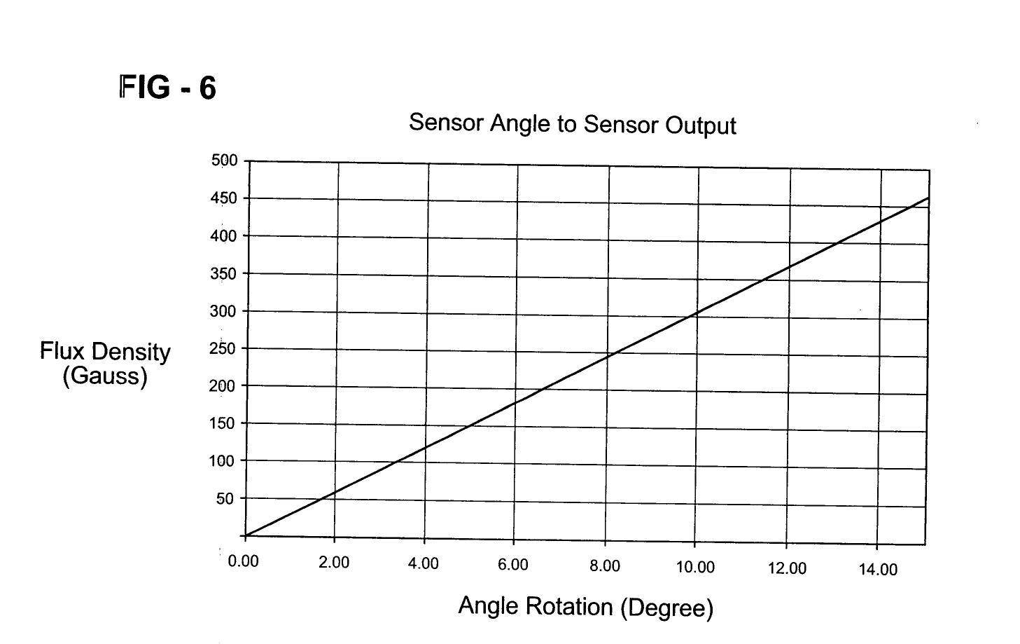

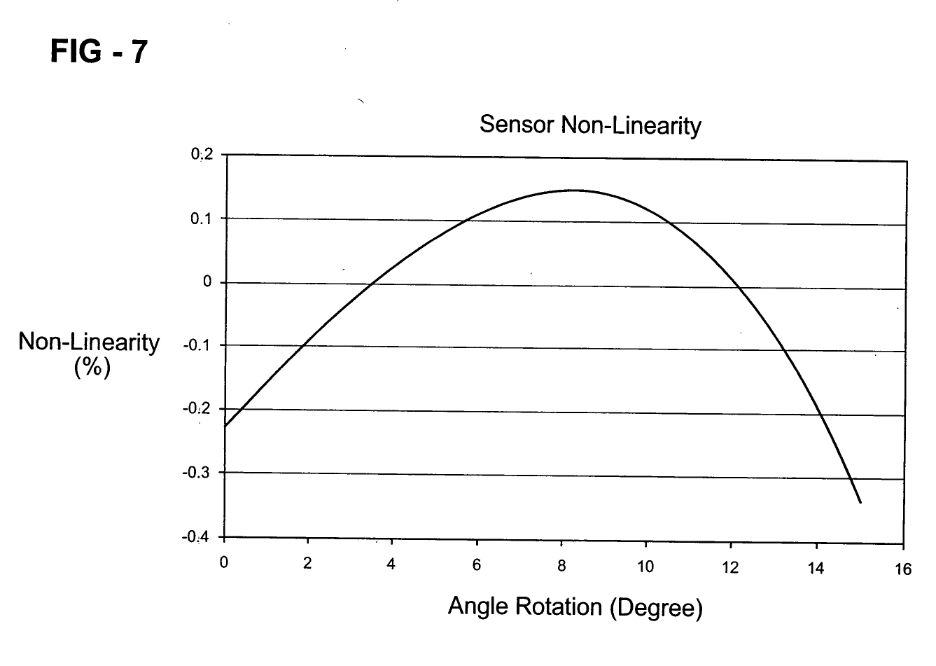

To determine non-linearity of the sensor, the output signals B_{y} from the magnetic flux sensor 24 are taken at a rest position and at full rotation of the pedal arm 14, 114, 214, preferably fifteen degrees of rotation. Preferably, the face 34 is perpendicular to the opposing surfaces 30, 32 at the rest position, which preferably produces an output signal B_{y} of zero Gauss so that if the position sensor 22 experiences mechanical or electrical failure, performance related to the position of the pedal arm 14, 114, 214 is not initiated. The output signals are plotted on a graph relative to angular rotation to establish a full range of output signals. A straight line is drawn between the output signals. Referring to FIG. 6, actual output signals B_{y} are measured at various angles θ between zero and the full rotation of the pedal arm 14, 114, 214 to determine deviations between the straight line and the actual output signal B_{y} at the various angles θ. Although the plot of FIG. 6 appears to be a straight line, it is to be appreciated that there are small deviations that are not perceivable. However, the deviations are perceivable when the non-linearity is determined from the actual output signals B_{y} of FIG. 6. Referring to FIG. 7, the deviations are divided by the full range of output signals and plotted on a graph to establish a non-linearity, as a percent of the full range of output signals, of the non-contact position sensor 22 at the various angles θ. A best fit plot is adapted from the output signals B_{y}. Smaller values for non-linearity per degree of rotation correlate to more accurate output signals B_{y}. The output signals B_{y} indicate a non-linearity per degree of rotation in a range of between 0.06 and 0.1 percent over a range of from zero to fifteen degrees of rotation. The output signals B_{y} may be used to measure angles of rotation θ over the range of rotation of fifteen degrees without sacrificing performance related to the rotation of the pedal arm 14, 114, 214, such as braking or throttle control.

As shown in FIG. 3, the flux sensor 24 may include two Hall elements 24a, 24b for generating redundant output signals B_{y}. However, only one Hall element 24a, 24b is necessary for the flux sensor 24. Preferably, the flux sensor 24 is mounted to a plate 38. The plate 38 is connected to wires 40 for transferring the output signals B_{y} from the flux sensor 24 to the wires 40. The wires 40 extend from the plate 38 to a processor (not shown) in the vehicle. The magnetic flux sensor 24 is preferably supported by the fixed element 18 so that the wires 40 may be directly connected between the plate 38 and the processor. In other embodiments, the magnetic flux sensor 24 may be supported by the rotatable element 20 and connected to the processor with a connector package (not shown) that rotates with the rotatable element 20. As such, the magnetic poles 26, 28 are preferably supported by the rotatable element 20, since the magnetic poles 26, 28 are not electrically connected to the processor.

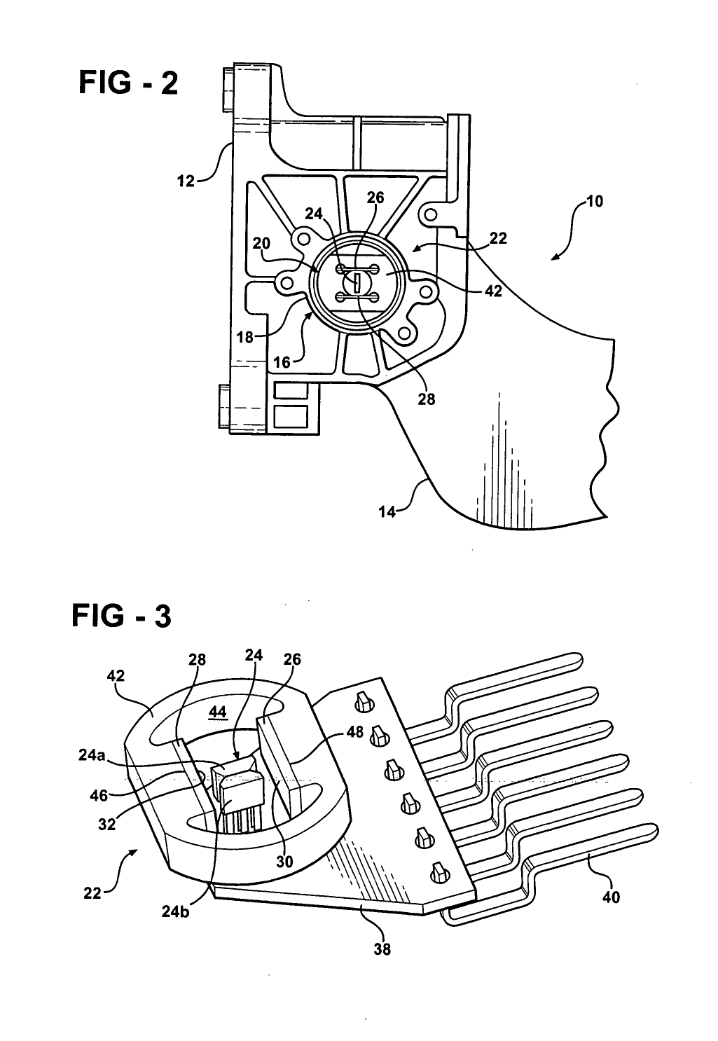

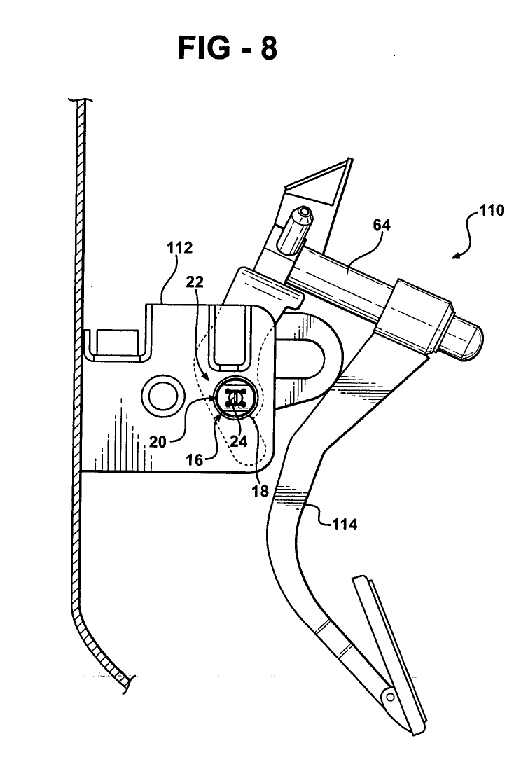

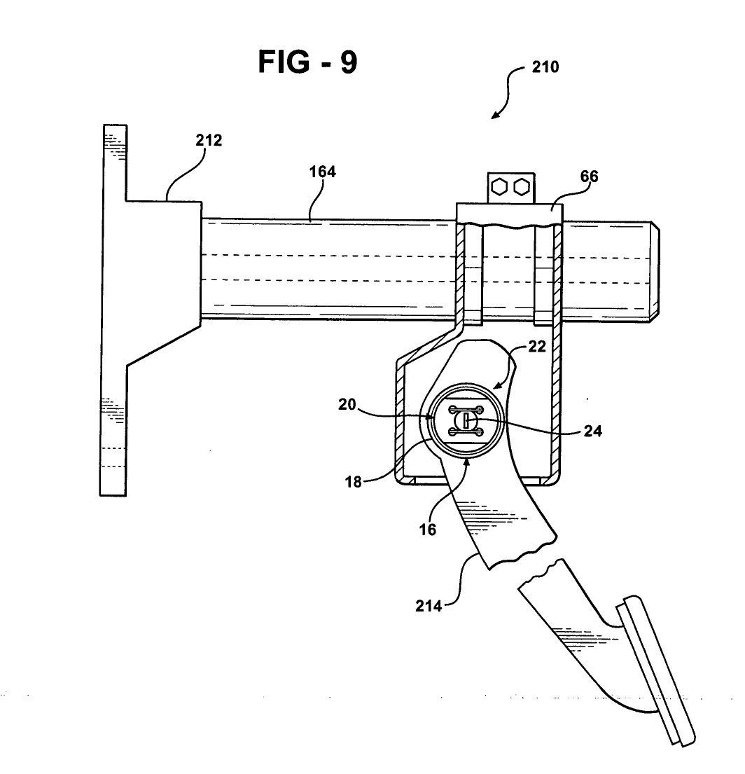

Various pedal assemblies 10, 110, 210 may include the position sensor 22 as described above. In one embodiment, as shown in FIGS. 1 and 2, the pedal arm 14 may be mounted to the bracket 12. The pedal assembly 10 is generally referred to as a “fixed” pedal assembly. In other embodiments, shown in FIGS. 8 and 9, the pedal assemblies 110, 210 are adjustable.

Referring to FIGS. 1 and 2, the pivot 16 is disposed between the bracket 12 and the pedal arm 14. Preferably, the fixed element 18 is included on the bracket 12 and the rotatable element 20 is included on the pedal arm 14, adjacent the fixed element 18. More specifically, the fixed element may include a housing 50 that covers and protects the flux sensor 24. The housing 50 is mounted to the bracket 12. The plate 38 may be mounted to the housing 50, with the wires 40 extending through the housing 50. A barrier plate 52 defines a hole 54. The barrier plate 52 fits over the flux sensor 24 and is mounted to the housing 50, with the flux sensor 24 extending through the hole 54. The rotatable element 20 is rotatable relative to the fixed element 18, about the pivot axis A, in response to the pivotal movement of the pedal arm 14. The rotatable element 20 includes the rotor 42, with the magnetic poles 26, 28 disposed on the inner surface 44 of the rotor 42. The rotatable element 20 further includes a connector 56 that defines a bore 58. The rotor 42 is seated in the bore 58 and is fixed to the connector 56 with a pin 62. The connector 56 is mounted to the pedal arm 14 for pivotal movement with the pedal arm 14. Bushings 60 are disposed between the rotatable element 20 and the bracket 12 for minimizing friction between the bracket 12 and the rotatable element 20 as the rotatable element 20 moves.

In another embodiment, shown in FIG. 8, the pedal assembly 110 further includes a guide member 64. The guide member 64 is rotatably supported by the bracket 112. The pedal arm 114 is supported by the guide member 64 for movement between fore and aft directions relative to the bracket 112. Thus, the pedal assembly 110 of FIG. 8 is referred to as an “adjustable” pedal assembly. The pivot 16 is disposed between the guide member 64 and the bracket 112, as opposed to between the pedal arm 114 and the bracket 112. Preferably, the fixed element 18 is included on the bracket 112 and the rotatable element 20 is included on the guide member 64, adjacent the fixed element 18. The rotatable element 20 is rotatable in response to the pivotal movement of the pedal arm 114 and the guide member 64.

In another embodiment, shown in FIG. 9, the pedal assembly 210 includes the guide member 164. The guide member 164 is fixed to the bracket 212. The pedal assembly 210 further includes a carrier 66. The carrier 66 is supported by the guide member 164 for movement in fore and aft directions relative to the bracket 212. The pedal arm 214 is supported by the carrier 66. Thus, the pedal assembly 210 of FIG. 9 is also referred to as an adjustable pedal assembly. The pivot 16 is disposed between the pedal arm 214 and the carrier 66. Preferably, the fixed element 18 is included on the carrier 66 and the rotatable element 20 is included on the pedal arm 214, adjacent the fixed element 218. As in the embodiment of FIGS. 1 and 2, the rotatable element 20 is rotatable in response to the pivotal movement of the pedal arm 214.

Obviously, many modifications and variations of the present invention are possible in light of the above teachings. It is, therefore, to be understood that within the scope of the appended claims, wherein reference numerals are merely for convenience and are not to be in any way limiting, the invention may be practiced otherwise than as specifically described.

1. A pedal assembly for a vehicle comprising:
a bracket for attachment to the vehicle;
a pedal arm;
a pivot supporting said pedal arm for pivotal movement relative to said bracket about a pivot axis and including a fixed element and a rotatable element rotatable relative to said fixed element about said pivot axis in response to the pivotal movement of said pedal arm;
a magnetic flux sensor supported by one of said elements;
first and second magnetic poles supported by the other of said elements
said flux sensor disposed between said first and second magnetic poles presenting opposing surfaces of opposite magnetic polarity;
said assembly characterized by said first and second magnetic poles disposed in spaced and parallel relationship to one another for creating substantially uniform flux density over a predetermined distance parallel to said surfaces of said magnetic poles.

2. A pedal assembly as set forth in claim 1 wherein said opposing surfaces are straight and create substantially parallel lines of magnetic flux between said surfaces along said predetermined distance.

3. A pedal assembly as set forth in claim 2 wherein said substantially uniform flux density is further defined as a difference in flux density of no more than 1500 Gauss throughout said predetermined distance.

4. A pedal assembly as set forth in claim 3 wherein said substantially uniform flux density is further defined as a flux density in the range of from 2000 to 3500 Gauss throughout said predetermined distance.

5. A pedal assembly as set forth in claim 3 wherein said flux sensor has a face that presents a straight longitudinal axis.

6. A pedal assembly as set forth in claim 5 wherein said face is perpendicular to said opposing surfaces.

7. A pedal assembly as set forth in claim 6 wherein each of said opposing surfaces extends a length at least equal to said space between said opposing surfaces.

8. A pedal assembly as set forth in claim 7 wherein said flux sensor is on said pivot axis and said predetermined distance is on either side of said pivot axis.

9. A pedal assembly as set forth in claim 8 wherein said predetermined distance is further defined as a distance at least equal to a length of said flux sensor.

10. A pedal assembly as set forth in claim 9 wherein said first and second magnetic poles are further defined as first and second magnets.

11. A pedal assembly as set forth in claim 10 wherein said other of said elements comprises a rotor coaxial with said pivot axis and having an inner surface radially spaced from and extending parallel to and about said pivot axis.

12. A pedal assembly as set forth in claim 11 wherein said first and second magnets are disposed on said inner surface of said rotor.

13. A pedal assembly as set forth in claim 12 wherein said rotor is formed from a material that is magnetizeable for facilitating magnetic lines of flux to extend from and between said magnets and through said rotor.

14. A pedal assembly as set forth in claim 13 wherein said magnetic flux sensor is supported by said fixed element.

15. A pedal assembly as set forth in claim 14 wherein said first and second magnetic poles are supported by said rotatable element.

16. A pedal assembly as set forth in claim 1 wherein said pivot is disposed between said bracket and said pedal arm.

17. A pedal assembly as set forth in claim 1 wherein said pedal assembly further comprises a guide member rotatably supported by said bracket.

18. A pedal assembly as set forth in claim 17 wherein said pivot is disposed between said guide member and said bracket.

19. A pedal assembly as set forth in claim 18 wherein said pedal arm is supported by said guide member for movement between fore and aft directions relative to said bracket.

20. A pedal assembly as set forth in claim 1 wherein said pedal assembly further comprises a guide member.

21. A pedal assembly as set forth in claim 20 wherein said pedal assembly further comprises a carrier supported by said guide member for movement in fore and aft directions relative to said bracket.

22. A pedal assembly as set forth in claim 21 wherein said pedal arm is supported by said carrier.

23. A pedal assembly as set forth in claim 22 wherein said pivot is disposed between said pedal arm and said carrier.

24. A non-contact position sensor disposed on a pivot axis, said sensor comprising:
a pivot including a fixed element and a rotatable element rotatable relative to said fixed element about said pivot axis;
a magnetic flux sensor supported by one of said elements on said pivot axis;
first and second magnetic poles supported by the other of said elements and presenting opposing surfaces of opposite magnetic polarity;
said flux sensor disposed between said first and second magnetic poles;
said position sensor characterized by said first and second magnetic poles disposed in spaced and parallel relationship to one another for creating substantially uniform flux density over a predetermined distance parallel to said surfaces of said magnetic poles.

25. A pedal assembly as set forth in claim 24 wherein said opposing surfaces are straight and create substantially parallel lines of magnetic flux between said surfaces on either side of said pivot axis.

26. A pedal assembly as set forth in claim 25 wherein said substantially uniform flux density is further defined as a difference in flux density of no more than 1500 Gauss throughout said predetermined distance.

27. A pedal assembly as set forth in claim 26 wherein said substantially uniform flux density is further defined as a flux density in the range of from 2000 to 3500 Gauss throughout said predetermined distance.

28. A non-contact position sensor as set forth in claim 26 wherein said flux sensor has a face that presents a straight longitudinal axis.

29. A non-contact position sensor as set forth in claim 28 wherein said face is perpendicular to said opposing surfaces.

30. A non-contact position sensor as set forth in claim 29 wherein each of said opposing surfaces extends a length at least equal to a space between said opposing surfaces.

31. A non-contact position sensor as set forth in claim 30 wherein said flux sensor is on said pivot axis and said predetermined distance is on either side of said pivot axis.

32. A pedal assembly as set forth in claim 1 wherein said predetermined distance is further defined as a distance at least equal to a length of said flux sensor.

33. A non-contact position sensor as set forth in claim 32 wherein said first and second magnetic poles are further defined as first and second magnets.

34. A non-contact position sensor as set forth in claim 33 wherein said other of said elements comprises a rotor coaxial with said pivot axis and having an inner surface radially spaced from and extending parallel to and about said pivot axis.

35. A non-contact position sensor as set forth in claim 34 wherein said first and second magnets are disposed on said inner surface of said rotor.

36. A non-contact position sensor as set forth in claim 35 wherein said rotor is formed from a material that is magnetizeable for facilitating magnetic lines of flux to extend from and between said magnets and through said rotor.

37. A non-contact position sensor as set forth in claim 36 wherein said magnetic flux sensor is supported by said fixed element.

38. A non-contact position sensor as set forth in claim 37 wherein said first and second magnetic poles are supported by said rotatable element.
